(19) United States
(12) Patent Application Publication
(10) Pub. No.: US 2004/0222697 A1
(43) Pub. Date: Nov. 11, 2004

(54) Elastomeric traction band with lug reinforcements

(76) Inventors: Gilles Soucy, Drummondville (CA); Marc Delisle, Sherbrooke (CA); Andre Deland, Drummondville (CA)

Correspondence Address: Robert Brouillette, BROUILLETTE KOSIE PRINCE, 25th Floor, 1100 Rene-Levesque Boulevard West, Montreal, QC, H3B 5C9, CA

(21) Appl. No.: 10/791,571

(22) Filed: Mar. 3, 2004

(30) Foreign Application Priority Data
Mar. 18, 2003 (CA) 2,422,481

(51) Int. Cl. B62D 55/24

(52) U.S. Cl. 305/165

(57) ABSTRACT

This invention relates to an endless elastomeric traction band that is used to propel tracked vehicles [i.e., vehicles which use endless traction bands rather than tires to contact the terrain over which they are driven, e.g., tractors, tanks, bulldozers, etc.] and, more particularly, to the inner surface of such a traction band where lug reinforcements are inserted to laterally reinforce the guide lugs and minimize de-tracking occurrences.

### FIELD OF INVENTION

This invention relates to an endless traction band that is used to propel tracked vehicles comprising guide lugs on its inner surface where lug reinforcements are inserted to laterally reinforce the guide lugs.

### BACKGROUND OF THE INVENTION

Numerous types of vehicles are frequently used on terrain where it is difficult for pneumatic tires to operate. Both defense vehicles, such as tanks and amphibious vehicles, and civilian vehicles, such as tractors and recreational vehicles, are sometimes utilized on terrains which are very soft, for example sand surfaces. Pneumatic tires are not capable of efficient operations on such soft surfaces, as they tend to burrow into the surface, rather than riding across it.

In the past, the most popular type of traction band for heavy duty vehicles have been those having metallic traction surfaces.

Recently, elastomeric endless traction bands have become popular due to an increase in construction, and in urban areas, where vehicles having traction bands must drive on the pavement and because there is a demand for vehicles used for low soil compaction farming, and over snow covered, very uneven, or muddy terrain. With the combination of elastomeric technology and a tremendous amount of trial and error, various types of traction bands using elastomeric materials are now available in the industry. They are used on excavators, dump carriers, boring machines, combines, tractors, and the like.

While endless traction bands using elastomeric materials are often desirable since they reduce damage to the terrain, reduce noise and allow access to various types of soil, they do have some drawbacks concerning their use. Once installed, the traction band is usually carried and maintained in tension by a plurality of rotating elements (wheels, sprockets, etc . . . ) that are connected to the vehicle. The rotating elements cooperate with the inner surface of the traction band which comprises a plurality of guide and drive lugs, therefore ensuring power transmission and lateral support to the traction band. The guide lugs are disposed in rows along the circumference of the traction band in order to offer lateral guidance by restraining the relative motion of the wheel-band assembly. The band can therefore rotate due to its drive lugs meshing with the drive or sprocket wheel.

However, since elastomeric bands are more easily deformed than metal bands, the wear and the use of the traction band under extreme conditions sometimes lead to de-tracking occurrences. De-tracking is mostly initiated by a combined action of friction and interference between the wheels and the guide lugs, which induces a lateral deformation of the elastomeric guide lugs. At this stage, the wheels are misaligned with the traction band and as the traction band continues to rotate and the guide lugs keep on laterally deforming, the rotating wheels sometimes climb on the lateral sides of the guide lugs, until de-tracking of the traction band is observed.

To avoid this problem, different guide lug configurations have been created from various elastomeric compositions or shapes. For instance, Tsunoda et al. (U.S. Pat. No. 6,300,396B1) and Muramatsu et al. (U.S. Pat. Nos. 5,447,365 and 5,540,489) have inserted in the guide lugs plate-like member or a rod-like member (Tsunoda et al. U.S. Pat. No. 5,948,438). The members have some low-friction surfaces exposed to the outside of the guide lugs which contact and collide with the wheels. These low-friction materials reduce de-tracking occurrences but to be effective, they need a direct contact with a wheel. Also, the lateral movement of the guide lugs with respect to the track is not significantly diminished under high lateral loads, even if a member has been inserted in the guide lug.

In Hori (U.S. Pat. No. 5,380,076) and in Togashi et al. (U.S. Pat. No. 5,295,741), core bars for crawler-type tracks are partially inserted in the elastomeric material, having a central portion which is not embedded in the elastomeric material and acts as a guide lug, and winged portions which are embedded in the elastomeric material. Even though core bars are rigidly connected with respect to the track, the “guide lug” portion of the central portion has a shape configuration which is restricted to the configuration of the wheels.

Since it is almost impossible to laterally or longitudinally enlarge the guide lugs because of their localization into the spacing generated by each wheel assembly, de-tracking events may still occur, especially when such a traction band is installed on a heavy and fast vehicle, like a defense vehicle.

The present invention sets out to solve the problem associated with de-tracking events by providing laterally reinforced guide lugs.

### SUMMARY OF INVENTION

The objective of this invention is to provide an innovative endless traction band which offers a workable solution to the de-tracking occurrences. The elastomeric bands are usually more easily deformed than metal bands. The wear and the use of the traction band under extreme conditions, like high lateral loads, sometimes initiates de-tracking events which are usually generated by a combined action of friction and interference between the wheels and the guide lugs.

In one embodiment, this invention introduces lug reinforcements to the endless traction band made from elastomeric materials, in the form of plates, reinforcement cords, rods or fabric destined to be inserted and integrally molded at a selected interval into the traction band. The lug reinforcements are disposed in such numbers, as required, to enhance the lateral rigidity of the traction band with respect to de-tracking occurrences.

In a preferred embodiment, each lug reinforcement laterally supports and reinforces a guide lug and comprises a reinforcing portion and two stabilizing portions on each side of the reinforcing portion. The stabilizing sides in each stabilizing portion are preferably flat, and embedded in the main band, and can either be positioned over or under the main tensile chords in the main band body.

The reinforcing portion preferably comprises reinforced members which longitudinally extend as vertically inclined planar area and connect to each other at an angle. In the case of plates, embossing may be used in the inclined planar area to optimize the lateral rigidity of the lug reinforcements.

Preferably, the total width of the reinforcing portion and the two stabilizing portions laterally extend at least as much as the lateral width defined by the two longitudinally split pair of wheels.

Lug reinforcements help to laterally stabilize the wheels/traction band assembly as the traction band rotates. The guide lugs lateral deformation by the wheels is reduced and preferably prevented by the lug reinforcements which provide a rigid lateral support. The reinforced members, with their vertically inclined planar areas, first support and then redirect the misaligned wheels toward their usual operating position.

There is therefore provided a traction band for use on a tracked vehicle comprising a plurality of wheels, said traction band being made of an elastomeric material, having an inner surface which faces said plurality of wheels and an outer surface which faces the surface over which the vehicle travels, comprising:

a band body;

at least one row of lugs which protrude along said inner surface of said traction band;

lug reinforcements having a reinforcing portion extending in said lugs and connected to at least one stabilizing portion embedded in said band body.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE FIGURES

FIG. 1 is an isometric view of a lug reinforcement in accordance with the invention;

FIG. 2 is an isometric view illustrating the lug reinforcement shown in FIG. 1, which is partly embedded in a guide lug.

FIG. 3 is a longitudinal view illustrating the lug reinforcement shown in FIG. 1.

FIG. 4 is a lateral view of a tracked vehicle making use of an endless traction band equipped with the lug reinforcements shown in FIG. 1.

FIG. 5 is a section view taken along line 5-5 in FIG. 4 showing one embodiment of the lug reinforcement.

FIG. 6 is a section view taken along line 5-5 in FIG. 4 showing another embodiment of the lug reinforcement.

FIG. 7 is top view of a traction band equipped with the lug reinforcements shown in FIG. 1.

FIG. 8 is a top view of another embodiment of the invention shown in FIG. 1.

FIG. 9 is an isometric view of another embodiment of the invention shown in FIG. 1.

FIG. 10 is an isometric view of another embodiment of the invention shown in FIG. 1.

FIG. 11 is a section view taken along line 5-5 in FIG. 4 showing another embodiment of the lug reinforcement.

### DETAILED DESCRIPTION OF A PREFERRED EMBODIMENT

A traction band equipped with lug reinforcements is described hereinafter according to a preferred embodiment of the present invention and illustrated in the appended figures.

FIG. 1 shows an isometric representation of a lug reinforcement 160 which consist of a formed plate, destined to be inserted and integrally molded into an endless rubber traction band, in order to enhance its lateral resistance with regards to de-tracking occurrences.

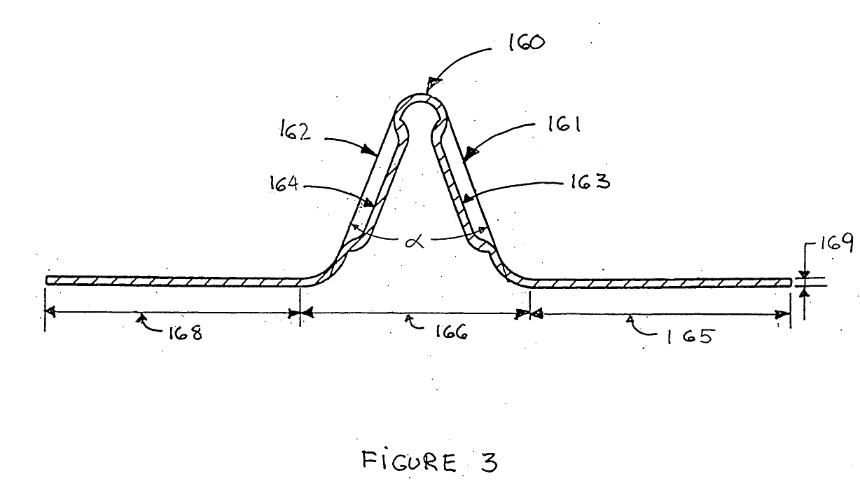

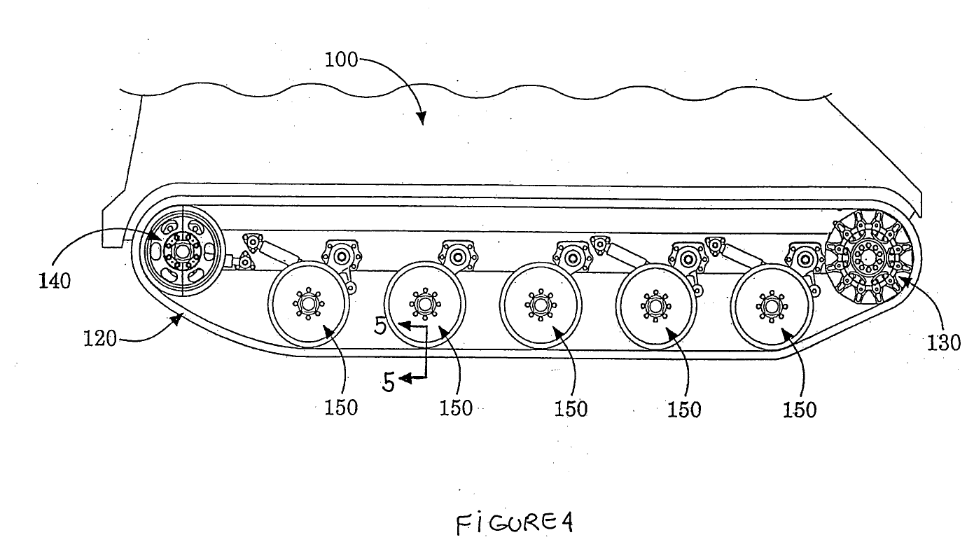

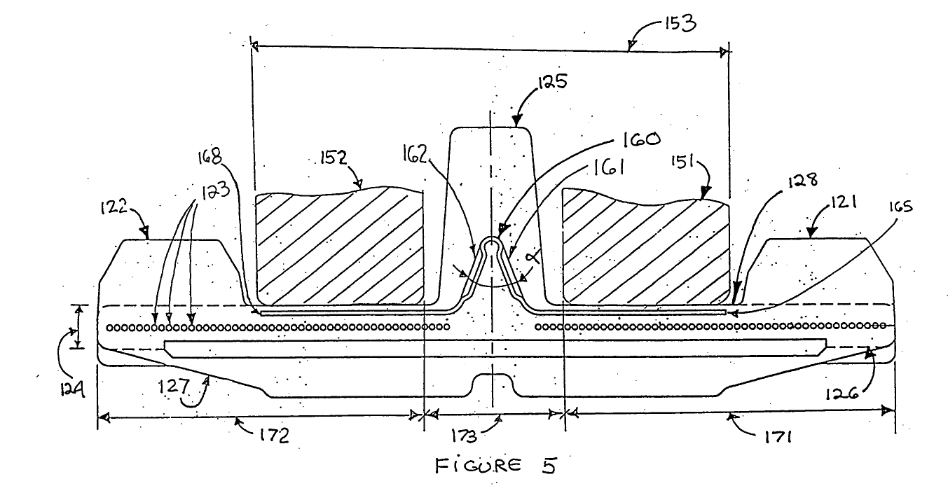

A vehicle 100 equipped with an endless traction band 120 is shown in FIG. 4. It comprises a sprocket drive 130 which allows power transmission from the vehicle 100 to the traction band 120, a tension wheel 140 and a plurality of road wheels 150 which support the vehicle and guide the traction band 120. This system is coupled to appropriate drive means (not shown) through an appropriate suspension system (not shown). A similar system is disposed on the other side of the vehicle 100.

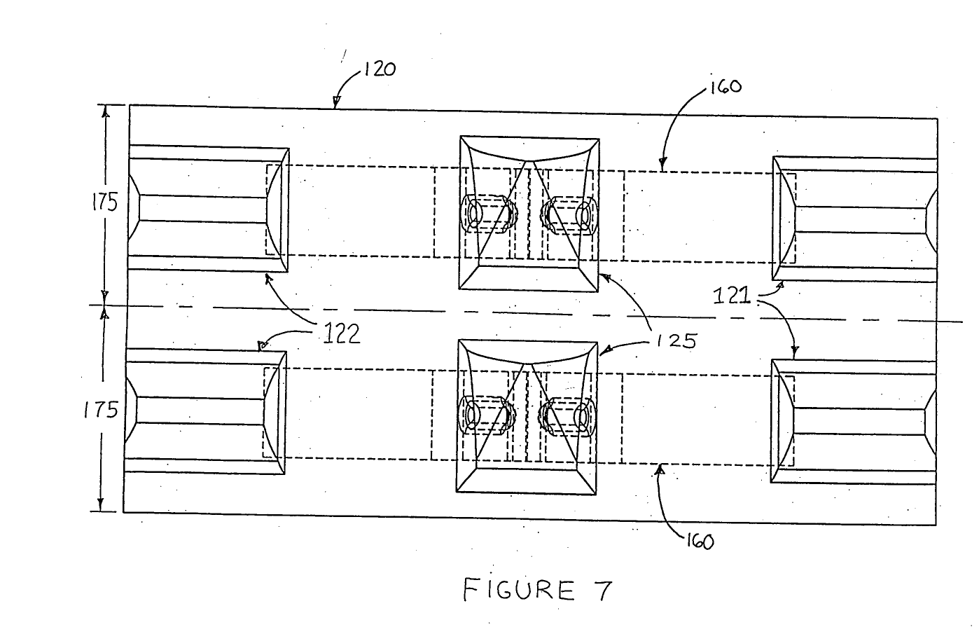

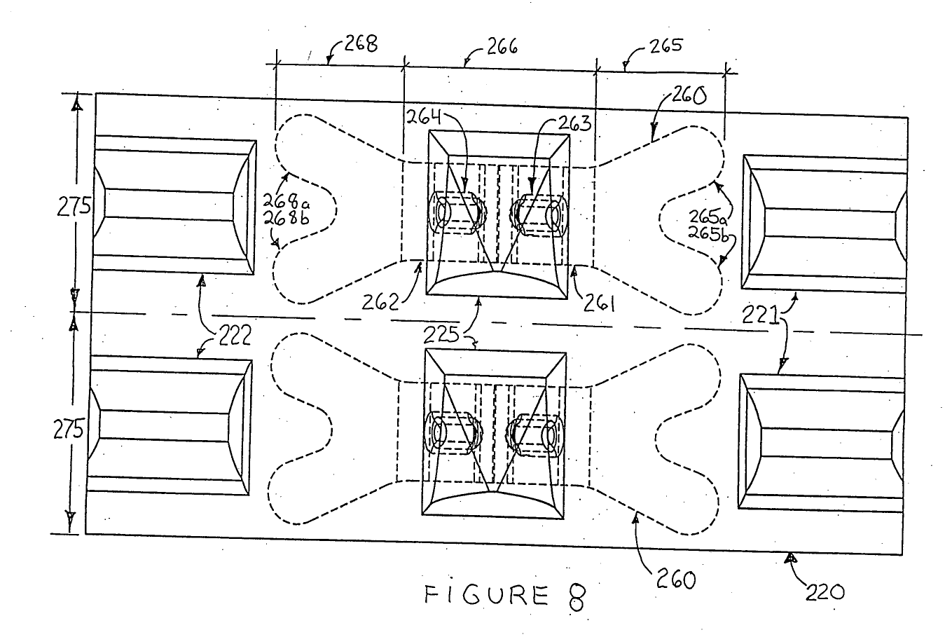

FIGS. 5 and 7 illustrate into more details the general configuration of a traction band 120 in accordance with the invention and show how it is mounted with respect to the vehicle 100 and its plurality of wheels (130, 140 and 150). In this embodiment, the traction band comprises a central band portion 173 and lateral band portions 171,172 which are located on each side of the central band portion 173. The inner surface 128 cooperates with the plurality of wheels 150 comprising sections (151 and 152 in FIG. 5) with the provision of rows of lateral drive lugs (121,122) and a row of central guide lugs 125 along the circumference of the traction band 120. Alternatively, as shown in FIG. 11, the drive lugs 522 are located in a central row and the guide lugs (522,526) are in two lateral rows on each side of the row of drive lugs 522.

The outer surface 126 supports the lug profiles 127 which come in multiple designs to adapt to various types of soil. The lug profiles 127 usually span over the entire lateral width of the endless elastomeric traction band 120 and along its entire circumference. Each lug profiles 127 are separated by flat areas 129, and their alternate sequence provides stability in rotation along the vertical axis (twisting) and the longitudinal axis (torsion) of the traction band, therefore minimizing de-tracking occurrences and ensuring a proper vehicle traction on snow.

The elastomeric traction band 120 is lightweight and pliable, yet reinforced with main tensile cords having fibers 123 which usually extend in a longitudinal direction and are located in the main band body 124 of the traction band 120.

As seen in FIGS. 4 and 5, the endless traction band 120 rotates around the tension wheel 140 and a plurality of road wheels 150, comprising a first section 151 and a second section 152. The row of guide lugs 125 is maintained in between the wheels (151,152) and therefore helps to laterally stabilize the wheels/traction band assembly as the traction band 120 rotates. When the traction band 120 is used under extreme conditions, de-tracking events sometimes occur, even if such guide lugs 125 are used.

It has been found that when lug reinforcements 160 are provided in the guide lugs 125, de-tracking occurrences are minimized, even after a combined action of high lateral forces on the traction band 120 are coupled with friction and interference between the wheels (130, 140 and 150) and the guide lugs 125.

For instance, when the traction band 120 in operation sees high levels of lateral forces, the guide lugs 125 laterally deform as some of the plurality of wheels (130, 140 or 150) start interfering and sometimes climbing on the guide lugs 125. At this stage, for traction bands of the prior art, a de-tracking event is initiated. However, the use of lug reinforcements 160 significantly reduces the occurrence of de-tracking by considerably limiting the deformation of the elastomeric material with the provision of a rigid lateral support.

A lug reinforcement 160 is inserted in the traction band 120 to laterally support and reinforce the guide lugs 125. In FIG. 7, each pitch 175 comprises a lug reinforcement (160 and shown in dotted line) which is preferably aligned in a lateral direction with a guide lug 125 and the drive lugs (121,122), along the entire circumference of the traction band 120.

FIGS. 1 and 3 describe in detail the physical characteristics of a lug reinforcement 160 in a preferred embodiment. Each lug reinforcement 160 either consists in a formed plate, a matrix of cords, rods or fabric which comprises a reinforcing portion 166 and two stabilizing portions (165,168), which are located on each side of the reinforcing portion 166. Any material that can be formed or allow the configuration or assembly of a more rigid structure than the elastomeric material, like for instance steels, textiles, polymers or other metal alloys, can be used.

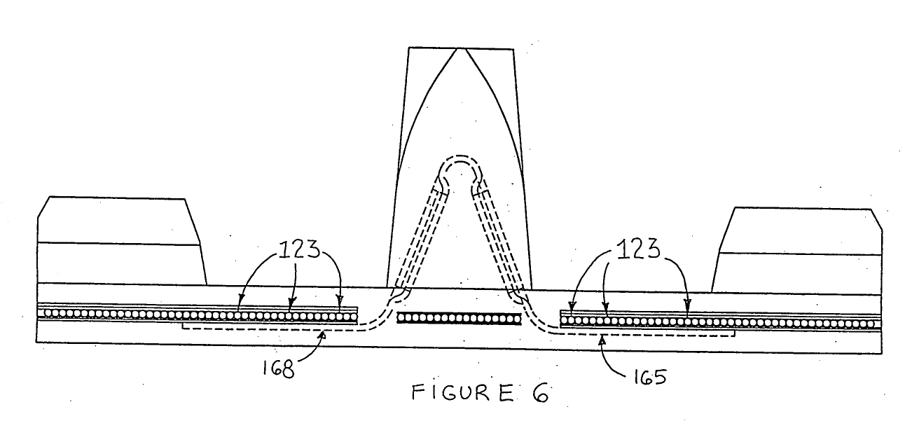

The stabilizing portions (165,168) are preferably flat, since their requirement is to locate and maintain the position of the lug reinforcement 160. As seen in FIG. 5, the stabilizing portions (165,168) are embedded in the main band body 124 and located underneath the plurality of road wheels (151,152), under the vehicle's weight as the band 120 rotates. Preferably, the total width of the reinforcing portion 166 plus the two stabilizing portions (165,168) laterally extends at least as much as the lateral width 153 defined by the two longitudinally split sections (151,152) of wheels (150). The stabilizing portions (165,168) are embodied in the main band body 124 and positioned over the fibers 123, or under the fibers 123, as illustrated in FIG. 6.

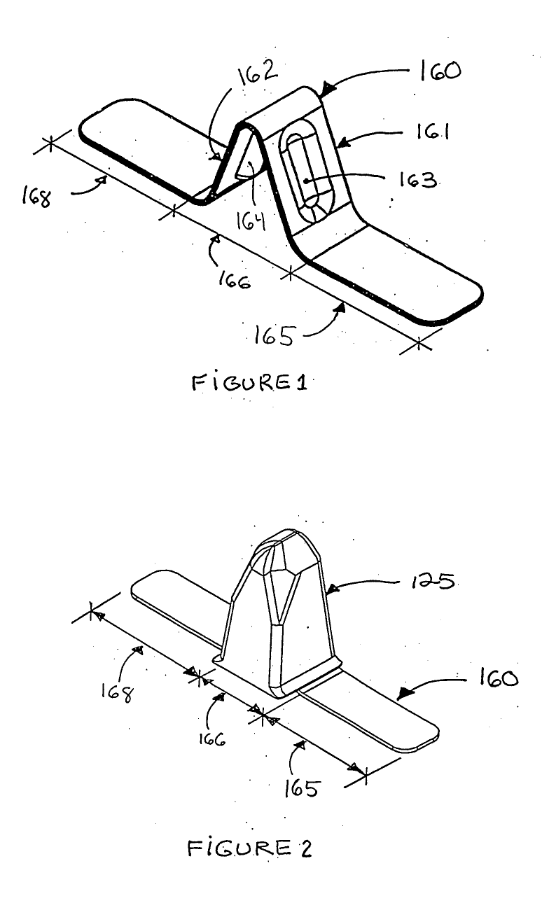

The reinforcing portion 166 comprises a formed plate or fabric structure, configured to provide tensional rigidity to the guide lugs 125 and which is preferably completely embedded in it, as shown in FIG. 2.

In the preferred embodiment illustrated in FIG. 1 and 5, the reinforcing portion 166 comprises inclined planar areas (161,162) which extend in a longitudinal direction and connect to each other at an angle α. The angle α is selected so that each inclined planar areas (161,162) is contained within the volume delimited by the corresponding guide lug 125, which in turn has a lateral width constraint. Indeed, the central band portion 173 of FIG. 5, where the guide lug 125 is located, is generally determined by the fixed spacing between the two longitudinally split sections (151,152) of wheels 150.

In order to optimize the lateral rigidity of the lug reinforcements 160, embossings (163,164) can be added to the inclined planar areas (161,162) when a rigid material is used. High lateral loads on the lug reinforcement 160 induce moments on the reinforced members 161 along a longitudinal axis, especially when they are applied at a higher distance from the stabilizing portions (165,168). A formed plate has less inertial resistance to such a moment, due to its small thickness 169, but embossings (163,164) enhance its inertial resistance to lateral forces. The embossings (163,164) can be concave or convex, of any shape or size, being only limited by the available volume space inside each guide lug 125. Other strengthening means can also be added to the reinforcing portion 166 to provide a similar lateral rigidity as the embossings (163,164) does for the inclined planar area (161,162).

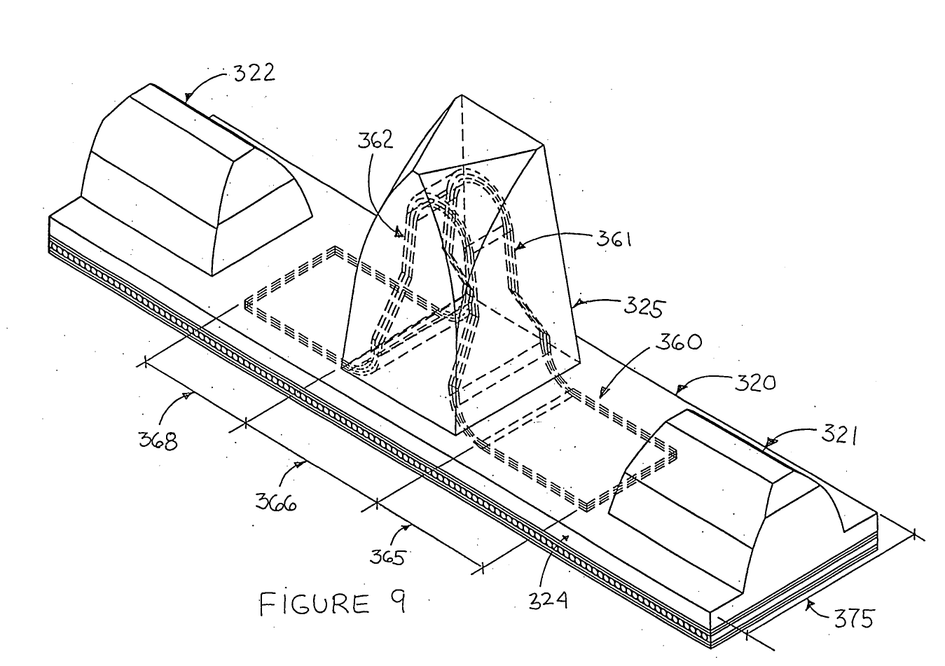

In the second embodiment shown in FIG. 8, lug reinforcements 260 are embedded in each pitch 275 of the traction band. A lug reinforcement 260 comprises a reinforcing portion 266, mainly located in the guide lug 225 and two stabilizing portions (265,268), each embedded in the band 220 and mostly between the drive lug (221,222) and the guide lug 225. The reinforcing portion 266 has inclined planar areas (261,262), with or without embossings (263,264). The inclined planar areas (261,262) extend in a longitudinal direction, connect to each other at an angle α. (not shown) and are contained within the volume of a guide lug 225. The stabilizing portions (265,268) may be provided with two arms (265a,265b and 268a,268b) in a V-shaped configuration which offers a wider and more stable section of the stabilizing portion (265,268) under the wheels.

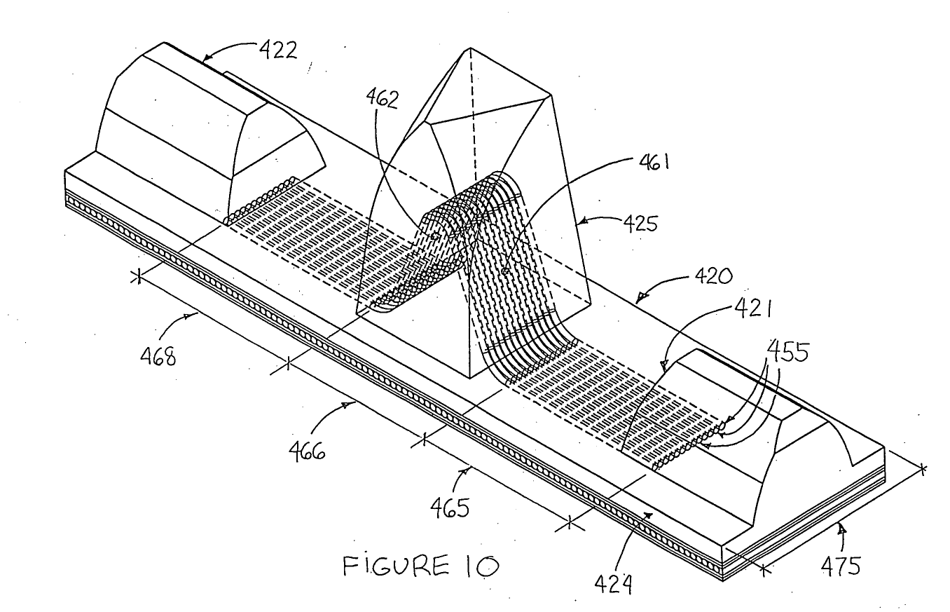

FIG. 9 illustrates a third embodiment of the invention, where each pitch 375 of the traction band 320 comprises a lug reinforcement 360 having a reinforcing portion 366 and two stabilizing portions (365,368) on each side of the reinforcing portion 366. Each stabilizing portion (365,368) is embedded in the band body 324, mostly in-between the drive lug (321,322) and the guide lug 325. The reinforcing portion 366 is made of two longitudinally extending inclined planar areas (361,362), connected to each other at an angle α. In this embodiment, each inclined planar area (361,362) has a longitudinally variable width in order to occupy, and therefore reinforce, most of the volume of the guide lugs 325.

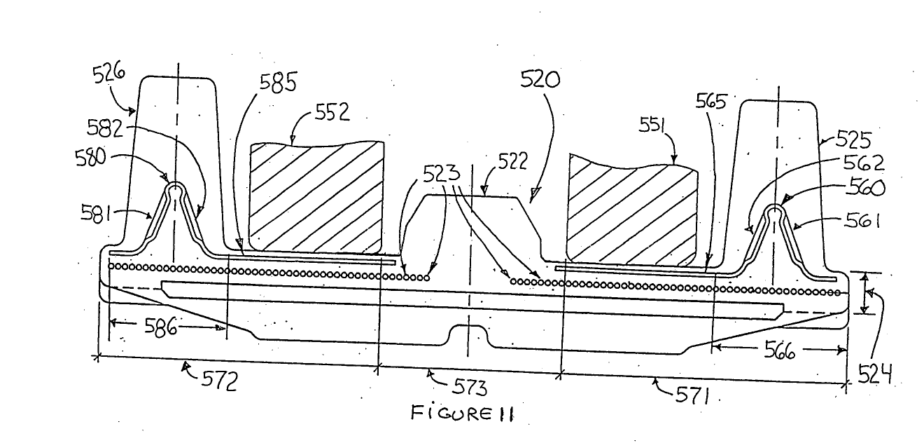

A fourth embodiment is described in FIG. 10. In each pitch 475 of the traction band 420, a lug reinforcement 460 is made of a selected number of cords or rods 455. Each cords or rods 455 have a lateral bi-dimensional profile comprising a reinforcing portion 466 and a pair of stabilizing portion (465,468) located on each side of the reinforcing portion 466. The reinforcing portion 466 is mainly located in the guide lug 425 and the longitudinal juxtaposition of each cords or rods 455 defines two inclined planar areas (461,462) at an angle α (not shown). The stabilizing portions (465,468) are embedded in the band body 424, mostly located between the drive lug (421,422) and the guide lug 425.

As seen in FIG. 4 and 5, the use of lug reinforcements 160 in a traction band 120 significantly reduces de-tracking events by reducing the deformation of the elastomeric material in the guide lugs 125. This phenomenon is firstly explained by the stabilizing portions (165,168) being embedded into the traction band 120 and located under the weight of at least part of the plurality of road wheels 150, therefore providing a laterally rigid and stable lug reinforcement with respect to the traction band 120. The reinforcing portion 166 act to significantly reduce the relative lateral movement between the rotating traction band 120 and the wheel 150 nearest to the high lateral load which is seeking to cause a de-tracking event. The inclined planar area (161,162), first supports and then redirects the misaligned wheel 150 toward the lateral band portions (171,172) as the band continues to rotate around the plurality of wheels (130, 140 and 150). The vehicle 100 can therefore continue to move since the high lateral load source on the terrain is absorbed by the traction band 120 and the de-tracking event avoided.

If the high lateral load source is felt on one of the arched portion of the traction band 120, which represents the band portions near the tension wheel 140 or the sprocket wheel 130, the lateral support offered by the lug reinforcements 160 is also enhanced since the guide lugs 125 get closer to one another in that portion of the band 120. Consecutive guide lugs 125 in those arched portions have closer lug reinforcements 160 with closer consecutive inclined planar areas (161,162) which provide a more integral lateral band support to the wheel/traction band assembly.

Another traction band embodiment which can be useful for other configurations of tracked vehicle is illustrated in FIG. 11. The traction band 520 has a reversed lug configuration when compared to the preferred embodiment of FIG. 5. On the central band portion 573, which is generally determined by the fixed spacing between the two longitudinally split sections (551,552) of wheels 550, one row of drive lugs 522 ensures power transmission from the vehicle to the traction band 520. Two rows of guide lugs (525,526) are located on each lateral band portions (571,572) and are reinforced by lug reinforcements (560,580), above the main tensile cords 523. Each lug reinforcement (560,580) comprises a reinforcing portion (566,586) being contained in each guide lug (525,526) and at least one stabilizing portion (565,585) embedded in the band body 524. The reinforcing portion (566,586) can be made in any shape or form, but preferably has the same configuration as the other embodiments stated hereinabove. In FIG. 11, two inclined planar areas (561,562 and 581,582)) are connected to each other as the preferred embodiment. The stabilizing portions (565,585) extend laterally from the inclined planar areas (562,582) and covers at least the lateral band portions (571,572).

While a preferred embodiment of the invention has been described herein, it should be apparent to those skilled in the art that variations and modifications are possible without departing from the spirit of this invention.

1. A traction band for use on a tracked vehicle comprising a plurality of road wheels, said traction band being made of an elastomeric material, having an inner surface which faces said plurality of road wheels and an outer surface which faces the surface over which the vehicle travels, comprising:
a band body;
at least one row of lugs which protrude along said inner surface of said traction band;
lug reinforcements having a reinforcing portion extending in said lugs and connected to at least one stabilizing portion embedded in said band body.

2. A traction band as claimed in claim 1, wherein said band body comprises main tensile cords along its circumference and wherein said stabilizing portions are located above said main tensile cords.

3. A traction band as claimed in claim 1, wherein said band body comprises main tensile cords along its circumference and wherein said stabilizing portions are located under said main tensile cords.

4. A traction band as claimed in claim 1, wherein said reinforcing portion comprises longitudinally extending areas.

5. A traction band as claimed in claim 4, wherein said longitudinally extending areas are parallel planar areas.

6. A traction band as claimed in claim 4, wherein said longitudinally extending areas are inclined planar areas connected to each other.

7. A traction band as claimed in claim 6, wherein each reinforcing portion contains a laterally extending structure which laterally rigidifies said reinforcing portion.

8. A traction band as claimed in claim 7, wherein said laterally extending structure is an embossing on said longitudinally extending areas.

9. A traction band as claimed in claim 1, wherein said stabilizing portion is longitudinally extending.

10. A traction band as claimed in claim 1, wherein said band body comprises a longitudinally extending central band portion on said traction band and two lateral band portions located on each side of said central band portion.

11. A traction band as claimed in claim 10, wherein said guide lugs are located on said central band portion.

12. A traction band as claimed in claim 10, wherein said guide lugs are located on said lateral band portions.

13. A traction band as claimed in claim 1, wherein each said lug reinforcement is a rigid plate.

14. A traction band as claimed in claim 13, wherein said plate is a metal plate.

15. A traction band as claimed in claim 13, wherein said plate is a plastic plate.

16. A traction band as claimed in claim 1, wherein each said lug reinforcement is a plurality of generally parallel cords.

17. A traction band as claimed in claim 1, wherein each said lug reinforcement is a plurality of generally parallel rods.

18. A traction band as claimed in claim 1, wherein each said stabilizing portion comprises v-shaped extremities.

19. A traction band, as claimed in claim 1, wherein said stabilizing portions are laterally wider than said reinforcing portions.

20. A traction band, as claimed in claim 1, wherein the surface of said road wheels which faces said inner surface is positioned over said stabilizing portion.
